(19) United States
(12) Patent Application Publication
(10) Pub. No.: US 2002/0092957 A1
(43) Pub. Date: Jul. 18, 2002

(54) Foldable hook attachment fixture

(75) Inventor: James E. Martorelli, Palm Bay, FL (US)

Correspondence Address: CHRISTOPHER F. REGAN, ESQUIRE, ALLEN, DYER, DOPPELT, MILBRATH & GILCHRIST, P.A., P.O. Box 3791, Orlando, FL, 32802-3791, US

(73) Assignee: Jim's Wallpaper and Painting

(21) Appl. No.: 09/764,728

(22) Filed: Jan. 17, 2001

(51) Int. Cl. F16B 45/00

(52) U.S. Cl. 248/308; 248/205.3; 248/304

(57) ABSTRACT

A foldable hook attachment for a tool, such as a paintbrush, includes a base having a tool attachment surface, which generally conforms with a surface of the tool, and contains adhesive material for affixing the base to the tool. A collar is integral with the base and has a bore that frictionally and snugly retains a longitudinal leg of a hook element, while allowing the hook element to be rotated about an axis of the bore in response to a rotation force being applied to the hook element. A distal portion the longitudinal leg may be configured to frictionally engage the base, so as to facilitate retention of the hook element in an orthogonal orientation relative to the base.

### FIELD OF THE INVENTION

The present invention relates in general to articles of manufacture, in particular, to support attachments for tools, implements and the like, and is particularly directed to a new and improved hook attachment that facilitates hanging a tool, such as a paintbrush, on a support surface, such as the edge of a paint can, and which may be folded into a substantially flat, out-of-the-way orientation, when not being used to hang the tool.

### BACKGROUND OF THE INVENTION

A variety of tools that are used in an intermittent manner are typically simply laid down, at the most convenient place at the time, when not being employed to perform a task. A non-limiting example of such a tool is a paintbrush, which may typically be either laid in a generally flat or horizontal condition across the top of a paint can, on a protective medium, such as a dropcloth, step-ladder and the like, or placed inside a paint can or bucket in a generally vertical orientation, with the bristles resting in-the-paint on the bottom of the paint can, and the handle upright.

Laying the paint brush down on its side is unacceptable as it leads to drips, messy handles and paint cans, and does not protect a variety of media, such as clothing, from coming in contact with the paint on the brush, and also ‘gums up’ the paint on the brush, as it dries out in exposure to air. Simply placing the brush in standing condition inside the paint bucket is similarly undesirable, as it can lead to a messy handle, and distortion (bending of the tips) of the bristles, and paint riding up to high on the bristles.

Proposals to address this temporary tool placement problem have included relatively impractical modifications of the handle structure of the paintbrush, and cumbersome combination fixtures that physically attach to the paint can and the brush. For non-limiting examples of such prior art hardware arrangements, attention may be directed to the Howard U.S. Pat. No. 888,896, Hill U.S. Pat. No. 2,988,768 and Edelson U.S. Pat. No. 3,432,875. et al.

### SUMMARY OF THE INVENTION

The present invention is directed to a relatively inexpensive, hook fixture that is readily attachable to a tool, such as a paintbrush, and enables the tool to be easily hung on a support, such as the edge of a paint can, and which may be folded into a substantially flat, out-of-the-way orientation, when not in use. In a first embodiment, the hook attachment fixture includes a base of a durable, lightweight plastic, that may include a friction collar into which a foldable, generally U-shaped hook formed of a bent metal rod is inserted. The bottom of the base has a thin adhesive layer, such as a layer of double backed adhesive foam transfer tape, that is used to affix the hook attachment fixture to the tool or surface, in any orientation.

The collar comprises a length of high friction material, such as rubber and the like, and includes an axial bore sized slightly narrower than the outer diameter of the hook, so that the hook will be frictionally and snugly held by the collar. A distal end of one of the legs of the U-shaped hook is inserted into the bore of the collar, so as to be proximate the location of a depression, slot, hole, bump and the like that is adjacent to an edge of the base. In addition, that distal end of the leg is bent slightly outwardly away from its axis, in the plane of the hook. This prevents the leg from being readily extracted from the collar bore, and causes the bent distal end to come into contact with the top surface of the base when the hook is rotated about the longitudinal axis of the collar bore.

In addition, as the distal end of the leg engages the top surface of the base during rotation of the hook, the leg becomes canted slightly off the axis of the collar bore to resist but not prevent rotation of the hook. Further rotation of the hook brings the distal end of the leg into the slot in the base, so as to provide a quasi locking of the hook in an orientation orthogonal to the base, whereby the tool to which the fixture is attached may be ‘hung’ by the hook.

In a second embodiment, the base is configured as a relatively compact, generally flat base made of a durable, lightweight friction material such as synthetic rubber. The base has a bore that extends partially therethrough, and generally parallel to its upper and lower surfaces. The bore is sized to receive and snugly frictionally retain a leg of a generally U-shaped hook, so as to provide sufficient resistance that allows forced rotation of the hook, but leaves the hook in a relatively stable position once that rotational force has been removed. As such the hook may be rotated to and stably frictionally positioned at any rotational orientation within a 180° arc over the top of the base.

A third embodiment has a generally flat base with a stand-off or mesa solid which projects above a generally central portion of an edge of the base. As in the first and second embodiments, the edgewise dimensions of the base are defined so as to be readily accommodated by the dimensions of the tool surface upon which the bottom of the base is to be affixed. Also, the bottom of the base may be provided with a thin adhesive layer. Immediately adjacent to and extending away from the mesa is a depression in the base's upper surface. A bore in the mesa is sized to receive and snugly frictionally retain therein a generally J- or U-shaped hook. To prevent removal of the hook from the mesa bore, a distal end of the hook leg portion retained by the mesa bore may receive a bead of a pliable material, such as liquid plastic, rubber cement, and the like. When allowed to cure, the bead frictionally engages the depression, to assist in stably frictionally positioning the hook.

### BRIEF DESCRIPTION OF THE DRAWINGS

FIG. 1 is a perspective, partially exploded view of a first embodiment of the foldable hook attachment fixture of the present invention;

FIGS. 2 and 3 diagrammatically illustrate attachment of the foldable hook attachment fixture of FIG. 1 to a paint brush;

FIG. 4 is a plan view of the foldable hook attachment fixture of FIG. 1;

FIGS. 5 and 6 are respective end and side views of the foldable hook attachment fixture of FIG. 1;

FIG. 7 shows a hook friction collar employed in the foldable hook attachment fixture of FIG. 1;

FIG. 8 shows a hook for the attachment fixture of FIG. 1;

FIGS. 9 and 10 are respective plan and end views of a second embodiment of the foldable hook attachment fixture of the present invention;

FIG. 11 shows a hook for the attachment fixture of the embodiment of FIGS. 9 and 10.

FIGS. 12 and 13 are respective perpsective and side views of a third embodiment of the foldable hook attachment fixture of the present invention;

### DETAILED DESCRIPTION

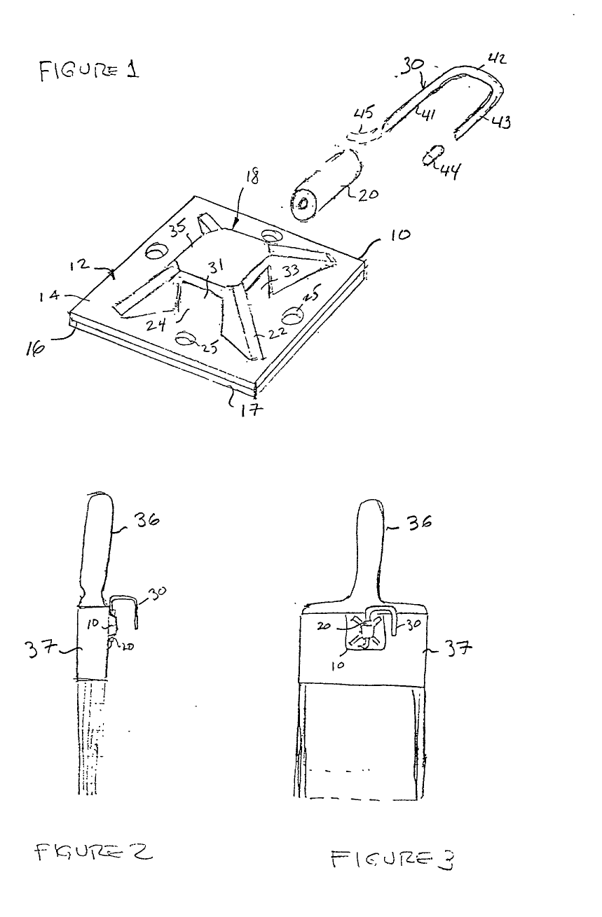

A perspective, partially exploded view of a first embodiment of the foldable hook attachment fixture of the present invention is diagrammatically illustrated in FIG. 1 as comprising a base 10 made of a durable, lightweight material such as molded plastic, that is configured to receive a friction collar or sleeve 20, into which a foldable, generally J- or U-shaped hook 30 is inserted and retained. The base 10 may comprise a single molded plastic piece, that includes a first, generally flat land portion 12 having generally flat top and bottom surfaces 14 and 16, respectively, and a hook collar retention portion 18, that is solid with and dimensioned above the top surface 14 of the land portion 12 so as to accommodate the collar 20.

The edgewise dimensions of the base 10 are defined so as to be readily accommodated by the dimensions of the tool surface upon which the bottom of the base is to be affixed. In the case of a paint brush, as a non-limiting example, diagrammatically illustrated at 36 in FIGS. 2 and 3, having a one and one-half to two inch wide ferrule 37, the edgewise dimension of a generally square shaped base 10 may be on the order of one and one-quarter inches, as a non-limiting example. In order to affix the hook attachment fixture of the invention to a tool surface, the bottom surface 16 of the base 10 is provided with a thin adhesive layer 17, such as a layer of industrial grade (flat or corrugated surfaced) double backed adhesive foam transfer tape, that is resistant to water, paint solvents, and the like.

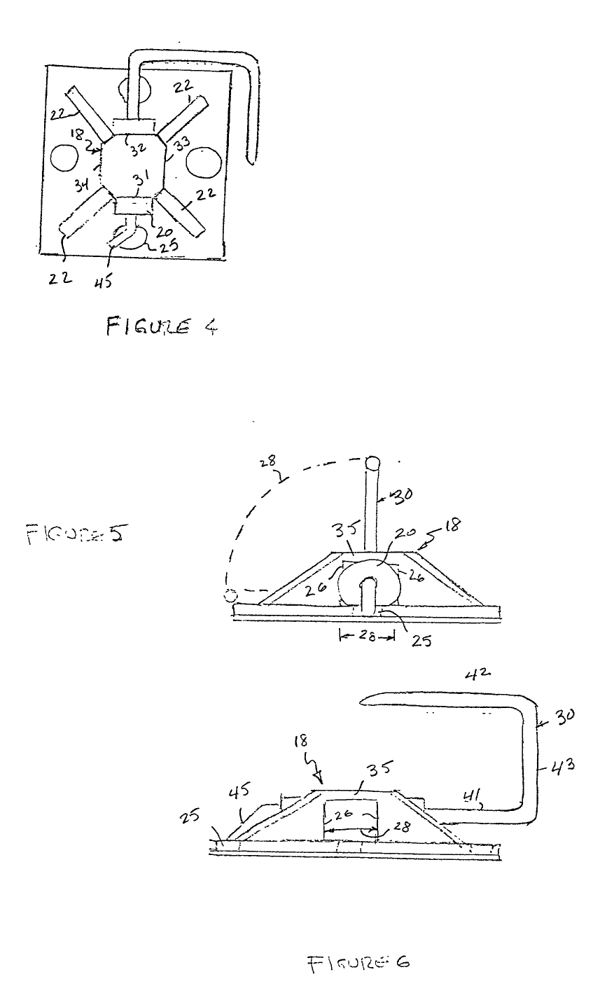

As shown in FIG. 1 and also in the top or plan view of FIG. 4, the hook collar retention portion 18 is formed of a plurality (four in the illustrated embodiment) of wall segments 22, which extend radially outwardly from a generally central region 24 of the top surface 14 of the flat land portion 12, where the friction collar 20 is retained. Employing a radial distribution of four wall segments provides for a mutually adjacent wall segment separation of 90°, so that the region 24 may be accessed through two orthogonal pairs of mutually opposed openings 31-32 and 33-34, to facilitate insertion of the collar 20.

As further illustrated in the respective end and side views of FIGS. 5 and 6, the interior ends 26 of the wall segments 22 are spaced apart from one another by a distance 28 that provides for a snug insertion of the hook-retaining friction collar 20 through one of the pairs of openings 31-32, 33-34 into the central region 24. The central region 24 is bounded by the interior terminal ends 26 of the wall segments 22 and a roof segment 35 that is solid with the wall segments 22 and overlies and defines the height of the collar retention openings 31-32, 33-34, and thereby the hook collar retention portion 18.

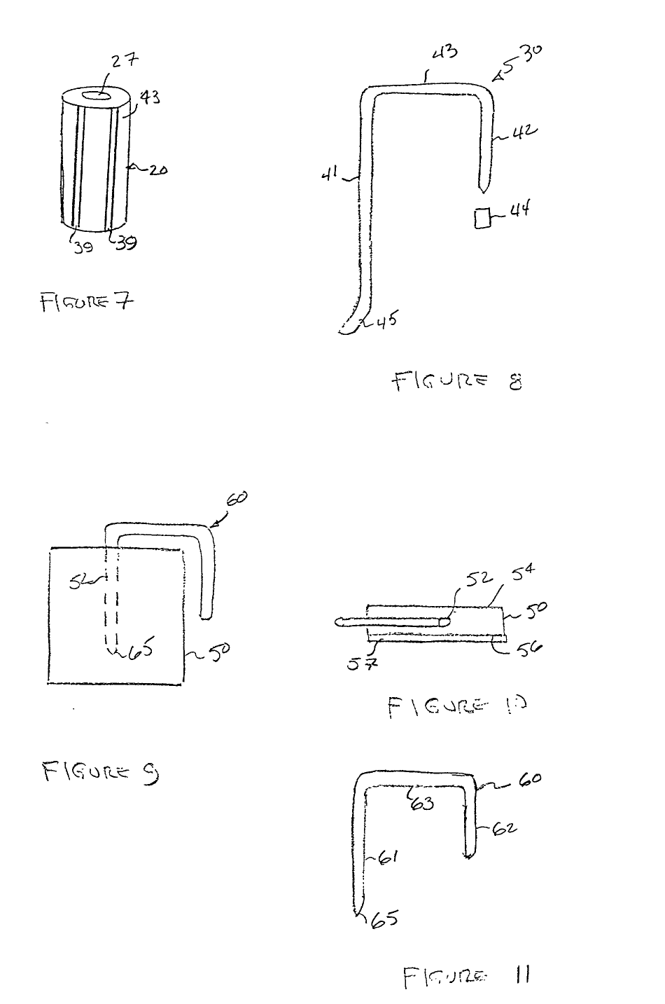

For securely retaining the hook 30, the collar 20 may comprise a length of generally cylindrically configured, high friction material, such as rubber and the like, shown in FIG. 7. The collar 20 may include a plurality of axially parallel ridges 39 along its outer surface 43, to facilitate its snug capture and retention in the base opening, between wall segments 22 and roof segment 35 of hook retention portion 18. The collar 20 includes an axial bore or slot 27 having a diameter that is slightly smaller than the outer diameter of the hook 30, so that, when inserted into the collar's axial bore, the hook will be frictionally snugly held by the collar.

The hook 30 is made of a robust material, such as a one-eighth inch diameter metal (e.g., stainless steel) rod, that is bent into a generally J- or U-shape, formed of a pair of leg portions 41 and 42 and an intermediate connecting portion 43 therebetween, as shown in FIG. 8. The leg portion 42 and its adjacent intermediate portion 43 form a generally J- or U-shaped hook for engaging a support surface, such as the top lip or edge of a paint can or bucket. A distal end of the (hook) leg portion 42 may optionally include a cap 44. The (longitudinal) leg portion 41, which may be slightly longer than the hook leg portion 42, is inserted into the axial bore 27 of the collar 20, as retained by the hook retention portion 18, so that its distal end 45 projects beyond the collar 20. The distal end is then bent slightly outwardly away from its leg axis, in the plane of the hook 30. The bent distal end 45 of the hook 30 projects beyond the end of the collar 30, as inserted in the hook retention portion 18 of the base 10, such that distal end 45 is proximate the location of a hole, depression, slot or the like 25 that is adjacent to an edge of the base 20.

This outward bending of the distal end 45 of the longer leg portion 41 serves to impede extraction of the leg portion 41 from the collar bore 27. It also causes the bent distal end 45 of the leg portion 41 of the hook to come into contact with the top surface 14 of the base 20, as the hook 30 is rotated about the longitudinal axis of the collar bore 27, such as from an out-of-the way or ‘folded-flat’ orientation against the base, to a more generally transverse orientation relative to the base in which the hook projects outwardly from the base for hanging the tool, as shown by dotted line 28 in FIG. 5.

As the distal end 45 of the leg portion 41 engages the top surface 14 of the base during rotation of the hook 30, the leg portion 41 becomes canted slightly off the axis of the friction collar bore 27, as the collar bore 27 becomes slightly elastically compressed by the radial force of the leg portion 41 acting against it. This provides resistance against, but does not completely prevent further rotation of the hook 30. Further rotation of the hook brings the distal end 45 of the leg portion 41 into a position where the distal end 45 is aligned with and enters the hole 25 in the base, to provide a quasi locking of the hook 30 in an orientation that is orthogonal to the base 20. In such a ‘hook’ orientation, the hook 30 does not readily rotate about the axis of the collar bore 27, so that a tool to which the fixture is attached may be securely ‘hung’ by the hook 30.

To return the hook to its out-of-the-way orientation, it is only necessary to push against either side of the leg portion 41, rotating the hook 30 about the collar bore axis 27 (along dotted lines 28 in FIG. 5) from its orthogonal orientation (at 90° from the surface of the base), to bring the longitudinal leg portion 41 of the hook into a generally flush condition with the plane of the base 20 or surface of the tool to which the base is affixed.

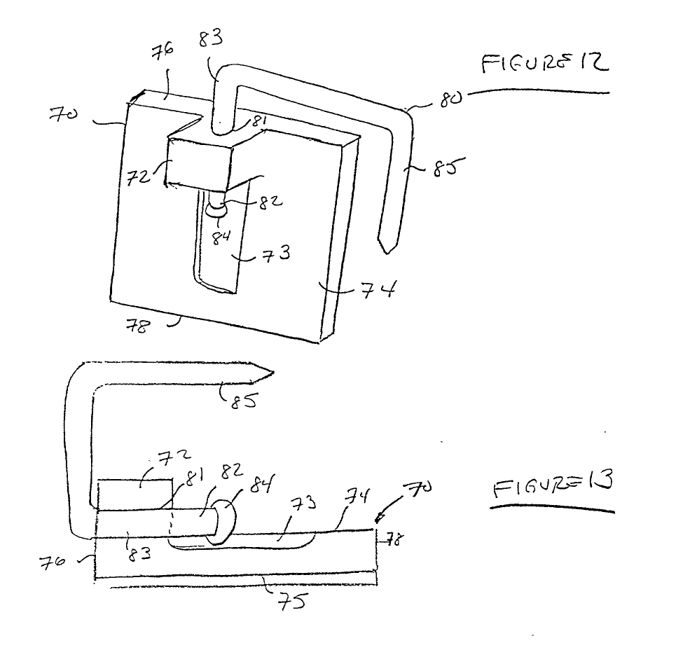

Respective plan and end views of a second embodiment of the foldable hook attachment fixture of the present invention are diagrammatically illustrated in FIGS. 9 and 10 as comprising a relatively compact, generally flat base 50 made of a durable, lightweight friction material such as synthetic rubber, having a bore 52 that extends partially therethrough, that is generally parallel to respective upper and lower surfaces 54 and 56 of the base. The bore 52 is sized to receive and snugly frictionally retain therein a generally J- or U-shaped hook 60, shown in FIG. 11.

As in the first embodiment, the edgewise dimensions of the base 50 are defined so as to be readily accommodated by the dimensions of the tool surface upon which the bottom of the base 50 is to be affixed. The bottom surface 56 of the base 50 may be provided with a thin adhesive layer 57, such as a layer of double backed adhesive foam transfer tape, as described above.

As shown in FIG. 11, the hook 60 is comprised of a generally longitudinal leg 61, a ‘hook’ leg 62 and an intermediate cross portion 63 therebetween, and a distal end of the hook leg portion 62 may include an optional cap 64. The longitudinal leg portion 61 may be slightly longer than hook leg portion 62, and is inserted into the axial bore 52 of the base, such that its distal end 65 terminates inside the bore. As in the first embodiment, the outer diameter of the longitudinal leg portion 61 has a diameter slightly larger than that of the bore 52 in the base 50, so that, when inserted into the collar's axial bore, the hook will be frictionally snugly held by the collar. As such the hook may be rotated to and stably frictionally positioned at any rotational orientation within a 180° arc over the top surface 54 of the base.

Once rotated to an orientation that is orthogonal to the base 50, the hook 60 will not readily rotate about the axis of the bore 52, so that a tool to which the fixture is attached may be ‘hung’ by the hook 60. To return the hook to an out-of-the-way orientation, it is only necessary to push against either side of the leg portion 61, rotating the hook 60 about the axis of the bore 52 from its orthogonal orientation (at 90° from the surface of the base), so as to bring the leg portion 61 of the hook into a generally flush condition with the plane of the base 50 or surface of the tool to which the base is affixed.

A third embodiment of the foldable hook attachment fixture of the present invention is illustrated in the perspective view of FIG. 12 and the diagrammatic side view of FIG. 13. As shown therein, a relatively compact, generally flat base 70 made of a durable, lightweight friction material such as synthetic rubber, and the like has a stand-off or mesa 72 solid therewith, which projects above a generally flat upper surface 74 of the base 70 adjacent to a generally central portion of an edge 76 of the base. As in the first and second embodiments, the edgewise dimensions of the base 70 are defined so as to be readily accommodated by the dimensions of the tool surface upon which the bottom of the base is to be affixed. The bottom surface 75 of the base 70 may be provided with a thin adhesive layer, such as a layer of double backed adhesive foam transfer tape, as described above.

Immediately adjacent to and extending away from the mesa 72 towards an opposite edge 78 of the base 70 is a recess or depression 73 in the base's upper surface 74. A bore 81 is formed through the mesa 72, so as to be generally parallel to the upper surface 74 of the base. Similar to the bore 52 in the second embodiment, the bore 81 through mesa 72 is sized to receive and snugly frictionally retain therein a generally J- or U-shaped hook 80 of the type shown at 60 in FIG. 11, described above. Thus, when inserted into the bore 81, the hook 80 will be frictionally snugly retained in the mesa.

In order to prevent removal of the hook 80 from the mesa bore 81, a distal end 82 of the hook leg portion 83 retained by the mesa bore 81 may receive a bead or drop 84 of a pliable material, such as liquid plastic, rubber cement, and the like. When allowed to cure, the bead 84 may frictionally engage the depression 73, so as to assist in stably frictionally positioning the hook 80 at any rotational orientation within a 180° arc over the top surface 74 of the base.

As in the second embodiment, once it has been rotated to an orientation that is orthogonal to the base 70, the hook 80 will not readily rotate about the axis of the bore mesa bore 81, so that a tool to which the fixture is attached may be ‘hung’ by the hook 80. To return the hook to an out-of-the-way orientation, it is only necessary to push against either side of the hook's extending leg portion 85, thereby rotating the hook 80 about the axis of the bore 81 from its orthogonal orientation (at 90° from the surface of the base), so that the leg portion 85 clears the base 70 and brings the hook 80 into a generally flush condition with the surface of the tool to which the base is affixed.

As will be appreciated from the foregoing description, the fixture of the present invention provides a relatively inexpensive, foldable hook attachment for a tool, such as a paintbrush, that enables the tool to be easily hung on a support, such as the edge of a paint can, by means of a projecting hook that may be readily folded into a substantially flat, out-of-the-way orientation, when not in use. Moreover, it should also be appreciated that, in addition to being configured as a discrete element, the folding hook fixture of the invention may be incorporated directly into the design of a paint brush ferrule, itself.

While I have shown and described several embodiments in accordance with the present invention, it is to be understood that the same is not limited thereto but is susceptible to numerous changes and modifications as known to a person skilled in the art, and I therefore do not wish to be limited to the details shown and described herein, but intend to cover all such changes and modifications as are obvious to one of ordinary skill in the art.

What is claimed:

1. An article of manufacture comprising:
base having a first side which generally conforms with a surface upon which said article of manufacture is to be mounted, and containing adhesive material for affixing said base to said surface;
a hook element having a generally longitudinal leg, and a hook portion extending from said leg; and
a collar integral with said base and having a bore bounded by material that is adapted to frictionally and snugly retain therein said leg, while allowing said hook element to be rotated about an axis of said bore, in response to a rotation force being applied to said hook element, but otherwise retaining said leg in a relatively fixed rotational position relative to said longitudinal axis of said bore.

2. The article of manufacture according to claim 1, wherein said base has a generally flat side that conforms with a generally flat surface of a tool upon which said article of manufacture is to be mounted, and has a layer of adhesive material for affixing said base to said surface, and is made of said material adapted to frictionally and snugly retain therein said generally longitudinal leg of said hook element.

3. The article of manufacture according to claim 1, wherein said base has a generally flat first side that conforms with a generally flat surface of a tool upon which said article of manufacture is to be mounted, and containing a layer of adhesive material for affixing said base to said surface, and a second side having a collar support portion that is configured to retain said collar.

4. The article of manufacture according to claim 3, wherein said collar comprises a mesa extending above said base and having a bore therein receiving said hook element.

5. The article of manufacture according to claim 4, wherein said hook element has a bead of frictional material thereon that assists in preventing removal of said hook from said mesa.

6. The article of manufacture according to claim 5, wherein said base has a depression formed in a surface thereof adjacent to said mesa.

7. The article of manufacture according to claim 3, wherein said collar includes a sleeve made of said material that is adapted to frictionally and snugly retain therein said generally longitudinal leg of said hook element, while allowing said hook element to be rotated about an axis of a bore through said sleeve, in response to a rotation force being applied to said hook element, but otherwise retaining said generally longitudinal leg of said hook element in a relatively fixed position relative to said axis of the bore through said sleeve.

8. The article of manufacture according to claim 7, wherein a portion said generally longitudinal leg is bent away from a longitudinal axis of said leg, so that rotation of said hook element about said axis of said bore brings said bent away portion of said generally longitudinal leg into engagement with a prescribed region of said second side of said base, and thereby retains said hook element in a prescribed orientation relative to said base.

9. The article of manufacture according to claim 8, wherein said prescribed region of said second side of said base is configured to receive said bent away portion of said leg as rotation of said hook element brings said distal end thereof into alignment with said prescribed region of said base, and provide a quasi locking of said hook element in an orientation that is generally orthogonal to said base, and thereby to said surface.

10. A foldable hook attachment fixture for a tool, such as a paintbrush, and the like, comprising:
a base having a tool attachment surface, which generally conforms with a surface of said tool, and contains adhesive material for affixing said base to said tool;
a hook element having a generally longitudinal leg, and a hook portion extending from said leg; and
a collar integral with a second side of said base and having a bore therethrough that is adapted to frictionally and snugly retain therein said leg, while allowing said hook element to be rotated about an axis of said bore in response to a rotation force being applied to said hook element, but otherwise retaining said leg in a relatively fixed rotational position relative to said axis of said bore; and wherein
a distal portion said leg is configured so that rotation of said hook element, from a folded orientation thereof adjacent to said base, about said axis of said bore causes said distal portion of said leg to be in frictional engagement with a prescribed region of said second side of said base, and thereby retains said hook element in a prescribed orientation relative to said base.

11. The foldable hook attachment fixture according to claim 10, wherein said distal portion of said leg includes a bent away portion of said leg that lies generally in a common plane containing said hook portion of said hook element, and wherein said base has a generally flat side that conforms with a generally flat surface of said too, and wherein said prescribed region of said second side of said base is devoid of material and sized to receive said bent away portion of said leg as rotation of said hook element brings said distal end thereof into alignment with said prescribed region of said base, and provide a quasi locking of said hook element in an orientation that is generally orthogonal to said base, and thereby to said surface of said tool.

12. A method of enabling a tool, such as a paintbrush, and the like, to be hung upon a support therefor, comprising the steps of:
(a) providing a foldable hook attachment fixture having
1-a base which generally conforms with a surface of said tool,
2-a hook element having a generally longitudinal leg and a hook portion extending from said leg, and
3-a collar integral with said base and having a bore bounded by material that is adapted to frictionally and snugly retain said leg, while allowing said hook element to be rotated about an axis of said bore in response to a rotation force being applied to said hook element, but otherwise retaining said leg in a relatively fixed rotational position relative to said longitudinal axis of said bore;
(b) affixing said base of said foldable hook attachment fixture to said surface of said tool; and
(c) rotating said hook element about said axis of said bore of said collar to bring said hook element to a prescribed rotational position generally transverse to said tool that allows said tool to be hung by said hook on said support surface.

13. The method according to claim 12, further including the step (d) of hanging said tool to said support therefor, by way of said hook element as rotated in step (c).

14. The method according to claim 13, further the step (e) of lifting said tool off said support therefor and rotating said hook element to a prescribed rotational position generally adjacent to said tool that allows said tool to be used with said hook in an out-of-the way orientation.

15. The method according to claim 12, wherein said base has a generally flat side that conforms with a generally flat surface of said tool and has a layer of adhesive material for affixing said base to said surface in step (b), and is made of said material that is adapted to frictionally and snugly retain therein said generally longitudinal leg of said hook element.

16. The method according to claim 12, wherein said base has a generally flat first side that conforms with a generally flat surface of said tool, and has a layer of adhesive material for affixing said base to said surface in step (b), and a second side having a collar support portion that is configured to retain said collar.

17. The method according to claim 16, wherein said second side of said base includes a recessed region that is adapted to receive and frictionally engage a distal portion of said leg and thereby retain said hook element in a generally orthogonal orientation relative to said base.

18. The method according to claim 12, wherein said collar comprises a mesa extending above said base and having a bore therein receiving said hook element.

19. The method according to claim 18, wherein said hook element has a bead of frictional material thereon that assists in preventing removal of said hook from said mesa.

20. The method according to claim 19, wherein said base has a depression formed in a surface thereof adjacent to said mesa.
